(19) United States
(12) Patent Application Publication
(10) Pub. No.: US 2019/0300220 A1
(43) Pub. Date: Oct. 3, 2019

(54) METHOD AND APPARATUS FOR RELEASING A BINDING ELEMENT IN THE FORM OF A METALLIC STRAP FROM A SHEET METAL ROLL

(71) Applicant: SUND BIRSTA AB, Sundsvall (SE)

(72) Inventors: Ove ENGLUND, Stockholm (SE); Erik DANIELSSON, Sundsvall (SE); Peter MÅRSTEDT, Stockholm (SE)

(21) Appl. No.: 16/315,857

(22) PCT Filed: Jun. 14, 2017
(86) PCT No.: PCT/SE2017/050631

§ 371 Date: Jan. 7, 2019

(30) Foreign Application Priority Data
Jul. 13, 2016 (SE) 1651054-7

(51) Int. Cl. B65B 69/00; B23K 26/364

(52) U.S. Cl. CPC B65B 69/0025; B23K 2101/16; B23K 26/364

(57) ABSTRACT

Method and apparatus for releasing a metallic binding element (10′) from a sheet metal roll (1), wherein an axial sheet metal edge (8) extends axially across the envelope surface (3) of the sheet metal roll, and wherein the binding element is secured to the sheet metal roll with pre-tension. The location of said axial sheet metal edge (8) or one or more axially protruding sheet metal edges at one of the gables of the sheet metal roll and the location of the binding element are detected to thereby establishing the location of a place where the binding element projects over a sheet metal edge under the formation of a gap (13′) between the binding element and the sheet metal roll. A laser beam (23) is focused onto a part (15′) of the binding element located above said gap in order to locally heat this part and thereby induce breakage of the binding element.

### FIELD OF THE INVENTION AND PRIOR ART

The present invention relates to a method according to the preamble of claim 1 and an apparatus according to the preamble of claim 7 for releasing an elongated binding element in the form of a metallic strap from a roll formed of wound sheet metal.

Sheet metal of steel or other metallic material obtained from a rolling mill is conventionally wound into a cylindrical roll. A strapping machine may be used for applying a binding element in the form of a strap of metallic material in a loop around the sheet metal roll, drawing the binding element tightly around the sheet metal roll and thereafter joining overlapping sections at the ends of the binding element in order to secure the binding element around the sheet metal roll and thereby prevent the sheet metal from being unwound from the sheet metal roll during storage and transportation thereof. Several such binding elements may be secured to the sheet metal roll at a distance from each other. Before using the sheet metal, it is necessary to release the binding elements from the sheet metal roll. This can of course be done manually with the assistance of a suitable cutting tool. However, the binding elements are normally tied very tightly to the sheet metal roll and are often secured to the sheet metal roll with high pre-tension, which makes it difficult to cut the binding elements manually and which also makes it dangerous for a person to be in the vicinity of the sheet metal roll at the moment when a binding element is cut off. Thus, there is a need for a convenient and safe manner of releasing a pre-tensioned binding element from a sheet metal roll.

### SUMMARY OF THE INVENTION

The object of the present invention is to achieve a new and favourable manner of releasing a pre-tensioned binding element in the form of a metallic strap from a sheet metal roll.

According to the invention, this object is achieved by means of a method having the features defined in claim 1 and an apparatus having the features defined in claim 7.

According the invention, the location of an axial sheet metal edge extending axially across the envelope surface of the sheet metal roll or the location of one or more axially protruding sheet metal edges at one of the gables of the sheet metal roll and the location of a binding element are detected by means of a detection device to thereby establish the location of a place where the binding element projects over a sheet metal edge under the formation of a gap between the binding element and the sheet metal roll. A laser beam is then focused onto a part of the binding element located above said gap in order to locally heat this part of the binding element and thereby induce breakage of the binding element. By means of the laser beam, it will be possible to achieve a very rapid and strong heating of a restricted and well-defined area on the binding element. By choosing a heating area located on a part of the binding element where the binding element is out of contact with the sheet metal roll, i.e. where there is a gap between the binding element and the sheet metal roll, the desired heating of the binding element may be achieved without causing heating damages to the sheet metal of the sheet metal roll. The tensile strength of the metallic binding element at the heated area is reduced as the temperature thereof increases, and when the heated area has reached a sufficiently high temperature the binding element will break at the heated area under the effect of the pre-tension in the binding element. Thus, the binding element may hereby be released from the sheet metal roll in a rapid and safe manner without damaging the sheet metal of the sheet metal roll.

Further advantages as well as advantageous features of the method and apparatus according to the present invention will appear from the dependent claims and the following description.

### BRIEF DESCRIPTION OF THE DRAWINGS

With reference to the appended drawings, a specific description of preferred embodiments of the invention cited as examples follows below. In the drawings:

FIG. 1 is a schematic perspective view of a sheet metal roll provided with four axially arranged binding elements,

FIG. 2 is a schematic view of a part of the sheet metal roll of FIG. 1 and a laser unit used for releasing the binding elements from the sheet metal roll,

FIG. 3 is a schematic perspective view of a sheet metal roll provided with two circumferentially arranged binding elements,

FIG. 4 is a schematic view of a part of the sheet metal roll of FIG. 3 and a laser unit used for releasing the binding elements from the sheet metal roll, and

FIG. 5 is an outline diagram of parts included in an apparatus according to an embodiment of the present invention.

### DETAILED DESCRIPTION OF EMBODIMENTS OF THE INVENTION

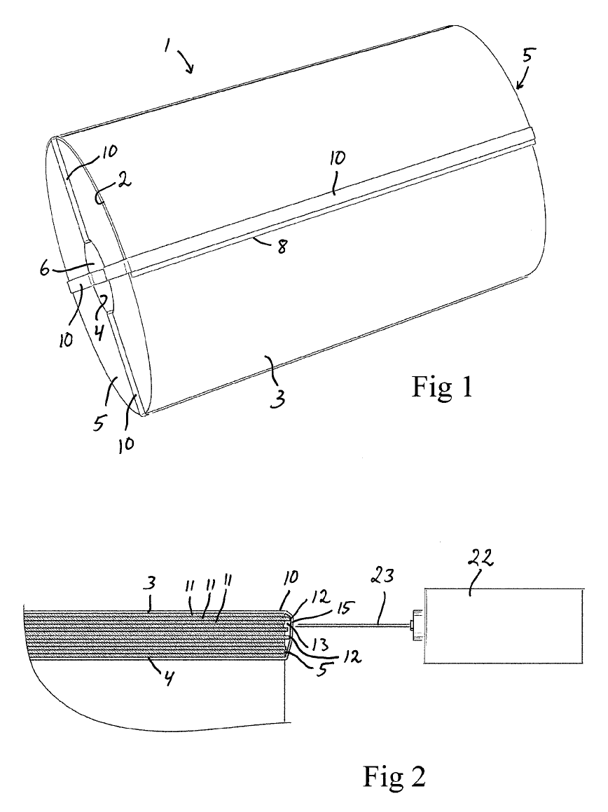

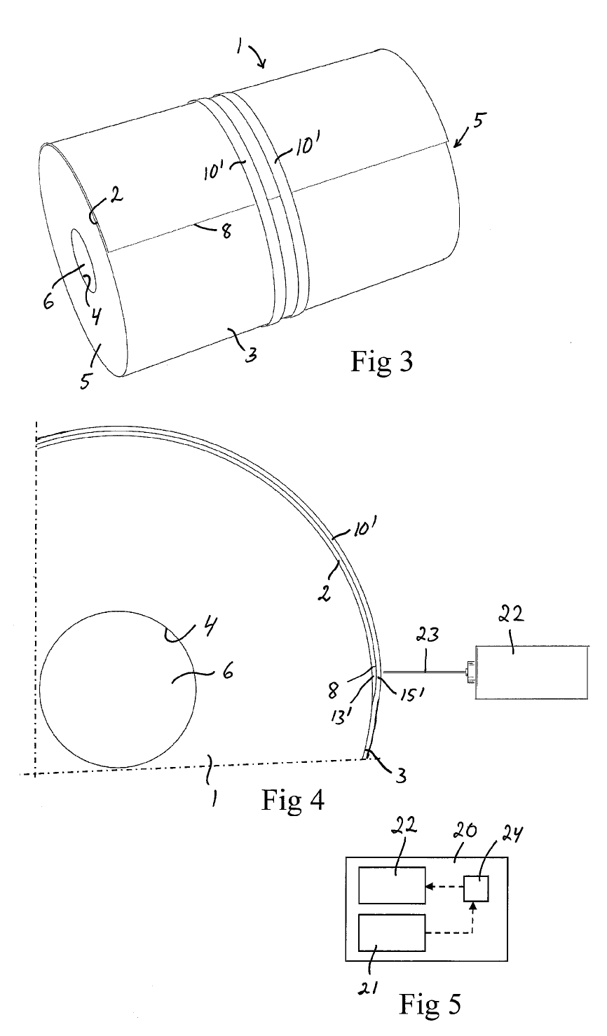

FIG. 1 and FIG. 3 schematically illustrate a roll 1 formed of wound sheet metal 2. The sheet metal roll 1 has an essentially cylindrical envelope surface 3, an essentially cylindrical inner surface 4 and two opposite annular gables 5. A through hole 6 extends between the gables 5 of the sheet metal roll 1 along the centre axis of the sheet metal roll, wherein said inner surface 4 constitutes the wall of this through hole 6. An edge 8 at the outer end of the wound sheet metal 2, i.e. at the sheet metal end located at the outer periphery of the sheet metal roll 1, extends axially across the envelope surface 3 of the sheet metal roll 1.

The sheet metal roll 1 is provided with at least one binding element 10, 10′ in the form of a strap of metallic material, for instance steel.

The sheet metal roll 1 illustrated in FIG. 1 is provided with four binding elements 10 distributed about the centre axis of the sheet metal roll, wherein each binding element 10 extends through the through hole 6 and is axially arranged around the sheet metal roll 1 in contact with the envelope surface 3, the inner surface 4 and the gables 5 thereof. The binding elements 10 are secured to the sheet metal roll 1 with pre-tension so as to prevent the sheet metal 2 from being unwound from the sheet metal roll 1 during storage and transportation of the sheet metal roll. Each binding element 10 is tightly tied to the sheet metal roll 1 and may be secured to the sheet metal roll 1 in a conventional manner, for instance by a sealed or sealless joint formed in mutually overlapped sections at the ends of the binding element 10. The number of binding elements 10 may of course vary in dependence on the size of the sheet metal roll 1.

Different sheet metal layers 11 in the sheet metal roll 1 may be somewhat offset in relation to each other, normally a few millimetres, in the axial direction of the sheet metal roll, as schematically illustrated in FIG. 2. Thus, there will be several axially protruding sheet metal edges 12 with intermediate valleys at each gable 5 of the sheet metal roll 1. As illustrated in FIG. 2, each binding element 10 projects over these sheet metal edges 12 under the formation of gaps 13 between the binding element 10 and the gable 5 of the sheet metal roll 1.

When a binding element 10 of the above-mentioned type is to be released from a sheet metal roll 1 of the type illustrated in FIG. 1, the location of one or more axially protruding sheet metal edges 12 at one of the gables 5 of the sheet metal roll 1 and the location of the binding element 10 are detected by means of a detection device 21 to thereby establish the location of the place where the binding element 10 projects over an axially protruding sheet metal edge 12 at this gable 5 of the sheet metal roll 1 under the formation of a gap 13 between the binding element 10 and this gable 5 of the sheet metal roll, whereupon a laser beam 23 is focused onto a part 15 of the binding element located above said gap 13 in order to locally heat this part 15 of the binding element and thereby induce breakage of the binding element 10.

The sheet metal roll 1 illustrated in FIG. 3 is provided with two binding elements 10′ secured to the sheet metal roll 1 in parallel with and at a distance from each other, wherein each binding element 10′ is circumferentially arranged around the sheet metal roll 1 in contact with the envelope surface 3 thereof so as to cross the above-mentioned axial sheet metal edge 8. The binding elements 10′ are secured to the sheet metal roll 1 with pre-tension so as to prevent the sheet metal 2 from being unwound from the sheet metal roll 1 during storage and transportation of the sheet metal roll. Each binding element 10′ encircles the sheet metal roll 1 in the circumferential direction thereof and is tightly tied to the envelope surface 3 of the sheet metal roll 1. Each binding element 10′ may be secured to the sheet metal roll 1 in a conventional manner, for instance by a sealed or sealless joint formed in mutually overlapped sections at the ends of the binding element 10′. The number of binding elements 10′ may of course vary in dependence on the size of the sheet metal roll 1.

As illustrated in FIG. 4, each binding element 10′ projects over the axial sheet metal edge 8 under the formation of a gap 13′ between the binding element 10′ and the envelope surface 3 of the sheet metal roll 1, wherein the size of this gap 13′ depends on the thickness of the sheet metal 2.

When a binding element 10′ of the above-mentioned type is to be released from a sheet metal roll 1 of the type illustrated in FIG. 3, the location of the axial sheet metal edge 8 and the location of the binding element 10′ are detected to thereby establish the location of the place where the binding element 10′ projects over the axial sheet metal edge 8 under the formation of a gap 13′ between the binding element 10′ and the envelope surface 3 of the sheet metal roll 1, whereupon a laser beam 23 is focused onto a part 15′ of the binding element located above said gap 13′ in order to locally heat this part 15′ of the binding element and thereby induce breakage of the binding element 10′.

Parts included in an apparatus 20 according to an embodiment of the present invention are very schematically illustrated in the outline diagram of FIG. 5. The apparatus 20 is to be used for releasing binding elements 10, 10′ of the above-mentioned types from a sheet metal roll 1. The apparatus 20 comprises a detection device 21 for detecting the location of the axial sheet metal edge 8 or one or more axially protruding sheet metal edges 12 and the location of a binding element 10, 10′ on a sheet metal roll 1 positioned in the working area of the apparatus 20, wherein the detection device 21, based on the detected location of said sheet metal edge or edges 8, 12 and the detected location of the binding element 10, 10′ is configured to establish the location of the place where the binding element 10, 10′ projects over a sheet metal edge 8, 12 under the formation of a gap 13, 13′ between the binding element 10, 10′ and the sheet metal roll 1. The detection device 21 may comprise a vision system or one or more ultrasonic sensors for detecting the location of said sheet metal edge or edges 8, 12 and the location of the binding element 10, 10′. As a further alternative, the detection device 21 may comprise one or more contact sensors for detecting the location of said sheet metal edge or edges 8, 12 and the location of the binding element 10, 10′, wherein the respective contact sensor is moved over a gable 5 or the envelope surface 3 of the sheet metal roll 1 and configured to emit a signal when it comes into contact with a sheet metal edge 8, 12 or the binding element 10, 10′. The detection device 21 may also comprise any other suitable type of sensors for detecting the location of said sheet metal edge or edges 8, 12 and the location of the binding element 10, 10′.

The apparatus 20 further comprises a laser unit 22 for emitting a laser beam 23 and an electronic control unit 24. The laser unit 22 comprises means of conventional type for directing and focusing the emitted laser beam 13 onto a desired target area. The electronic control unit 24 is connected to the detection device 21 in order to receive information from the detection device as to the location of the place where the binding element 10, 10′ projects over a sheet metal edge 8, 12 under the formation of a gap 13, 13′ between the binding element 10, 10′ and the sheet metal roll 1. The electronic control unit 24 is also connected to the laser unit 22 and configured to control the above-mentioned beam directing and focusing means of the laser unit to direct and focus the laser beam 23 of the laser unit onto a part 15, 15′ of the binding element located above said gap 13, 13′ in order to locally heat this part 15, 15′ of the binding element under the effect of the laser beam 23 to such a temperature that breakage of the binding element 10, 10′ is induced.

The invention is of course not in any way restricted to the embodiments described above. On the contrary, many possibilities to modifications thereof will be apparent to a person with ordinary skill in the art without departing from the basic idea of the invention such as defined in the appended claims.

1. A method for releasing an elongated binding element (10; 10′) in the form of a metallic strap from a roll (1) formed of wound sheet metal (2), the sheet metal roll (1) having an essentially cylindrical envelope surface (3), an essentially cylindrical inner surface (4) and two opposite annular gables (5), wherein an axial sheet metal edge (8) at an end of the wound sheet metal (2) extends axially across the envelope surface (3) of the sheet metal roll (1), and the binding element (10; 10′) is secured to the sheet metal roll (1) with pre-tension, the method comprising the steps of:
A) detecting the location of said axial sheet metal edge (8) or one or more axially protruding sheet metal edges (12) at one of the gables (5) of the sheet metal roll (1) and the location of the binding element (10; 10′) by a detection device (21) to thereby establishing the location of a place where the binding element (10; 10′) projects over a sheet metal edge (8; 12) under the formation of a gap (13; 13′) between the binding element and the sheet metal roll (1); and
B) focusing a laser beam (23) onto a part (15; 15′) of the binding element located above said gap (13; 13′) to locally heat this part (15; 15′) of the binding element and thereby induce breakage of the binding element (10; 10′).

2. A method according to claim 1, wherein the binding element (10′) is circumferentially arranged around the sheet metal roll (1) in contact with the envelope surface (3) thereof to cross said axial sheet metal edge (8), characterized in that the location of said axial sheet metal edge (8) and the location of the binding element (10′) are detected in step 1A to thereby establish the location of the place where the binding element (10′) projects over the axial sheet metal edge (8) under the formation of a gap (13′) between the binding element (10′) and the envelope surface (3) of the sheet metal roll (1).

3. A method according to claim 1, wherein the binding element (10) is axially arranged around the sheet metal roll (1) in contact with the envelope surface (3), the inner surface (4) and the gables (5) thereof, and the location of one or more axially protruding sheet metal edges (12) at one of the gables (5) of the sheet metal roll (1) and the location of the binding element (10) are detected in step (A) to thereby establish the location of the place where the binding element (10) projects over an axially protruding sheet metal edge (12) at this gable (5) of the sheet metal roll under the formation of a gap (13) between the binding element and this gable of the sheet metal roll (1).

4. A method according to claim 1, wherein a detection device (21) comprising one or more ultrasonic sensors is used for detecting the location of said sheet metal edge or edges (8; 12) and the location of the binding element (10; 10′).

5. A method according to claim 1, wherein a detection device (21) comprising a vision system is used for detecting the location of said sheet metal edge or edges (8; 12) and the binding element (10; 10′).

6. A method according to claim 1, wherein a detection device (21) comprising one or more contact sensors is used for detecting the location of the sheet metal edge or edges (8; 12) and the binding element (10; 10′).

7. An apparatus for releasing an elongated binding element (10; 10′) in the form of a metallic strap from a roll (1) formed of wound sheet metal (2), the sheet metal roll (1) having an essentially cylindrical envelope surface (3), an essentially cylindrical inner surface (4) and two opposite annular gables (5), wherein an axial sheet metal edge (8) at an end of the wound sheet metal (2) extends axially across the envelope surface (3) of the sheet metal roll (1), and the binding element (10; 10′) is secured to the sheet metal roll (1) with pre-tension, the apparatus comprising:
a detection device (21) for detecting the location of said axial sheet metal edge (8) or one or more axially protruding sheet metal edges (12) at one of the gables (5) of the sheet metal roll (1) and the location of the binding element (10; 10′), wherein the detection device (21), based on the detected location of said sheet metal edge or edges (8; 12) and the binding element (10; 10′) is configured to establish the location of a place where the binding element (10; 10′) projects over a sheet metal edge (8; 12) under the formation of a gap (13; 13′) between the binding element and the sheet metal roll (1);
a laser unit (22) for emitting a laser beam (23); and
an electronic control unit (24) connected to the detection device (21) and configured to control the laser beam (23) of the laser unit (22) to be focused onto a part (15; 15′) of the binding element (10; 10′) located above said gap (13; 13′) in order to locally heat this part (15; 15′) of the binding element and thereby induce breakage of the binding element (10; 10′).

8. An apparatus according to claim 7, wherein the detection device (21) comprises one or more ultrasonic sensors for detecting the location of said sheet metal edge or edges (8; 12) and the binding element (10; 10′).

9. An apparatus according to claim 7, wherein the detection device (21) comprises a vision system for detecting the location of said sheet metal edge or edges (8; 12) and the binding element (10; 10′).

10. An apparatus according to claim 7, wherein the detection device (21) comprises one or more contact sensors for detecting the location of said sheet metal edge or edges (8; 12) and the binding element (10; 10′).

11. A method according to claim 3, wherein a detection device (21) comprising one or more ultrasonic sensors is used for detecting the location of said sheet metal edge or edges (8; 12) and the location of the binding element (10; 10′).

12. A method according to claim 2, wherein a detection device (21) comprising one or more ultrasonic sensors is used for detecting the location of said sheet metal edge or edges (8; 12) and the location of the binding element (10; 10′).

13. A method according to claim 3, wherein a detection device (21) comprising a vision system is used for detecting the location of said sheet metal edge or edges (8; 12) and the binding element (10; 10′).

14. A method according to claim 2, wherein a detection device (21) comprising a vision system is used for detecting the location of said sheet metal edge or edges (8; 12) and the binding element (10; 10′).

15. A method according to claim 3, wherein a detection device (21) comprising one or more contact sensors is used for detecting the location of the sheet metal edge or edges (8; 12) and the binding element (10; 10′).

16. A method according to claim 2, wherein a detection device (21) comprising one or more contact sensors is used for detecting the location of the sheet metal edge or edges (8; 12) and the binding element (10; 10′).
